(19) United States
(12) Patent Application Publication
(10) Pub. No.: US 2011/0122301 A1
(43) Pub. Date: May 26, 2011

(54) IMAGING DEVICE AND IMAGING METHOD

(75) Inventors: Hidehiko YAMURA, Saitama (JP); Masayuki Koyanagi, Saitama (JP); Maki HAGIWARA, Saitama (JP)

(73) Assignee: FUJIFILM CORPORATION, Tokyo (JP)

(21) Appl. No.: 12/954,558

(22) Filed: Nov. 24, 2010

(30) Foreign Application Priority Data
Nov. 26, 2009 (JP) P2009-268831

(51) Int. Cl. H04N 9/09

(52) U.S. Cl. 348/262; 348/E09.006

(57) ABSTRACT

An imaging device includes a CCD-type solid-state imaging element, an imaging control section, a fill light firing section, and a light firing amount calculation section. The CCD-type solid-state imaging element includes a first photoelectric conversion element and a second photoelectric conversion element adjacent to the first photoelectric conversion element. A charge is independently readable from the first photoelectric conversion element and the second photoelectric conversion element. The imaging control section, in response to one photographing command, executes imaging by the solid-state imaging element in two exposure time periods of a first exposure time period exposing the first photoelectric conversion element and a second exposure time period exposing the second photoelectric conversion element. The second exposure time period overlaps the first exposure time period and is shorter than the first exposure time period. The fill light firing section fires fill light.

### CROSS-REFERENCE TO RELATED APPLICATIONS

This application is based upon and claims the benefit of priority from Japanese Patent Application No. 2009-268831, filed Nov. 26, 2009, the entire contents of which are incorporated herein by reference.

### BACKGROUND

1. Technical Field

This invention relates to an imaging device and an imaging method.

2. Back Ground

JP-A-2005-12315 and JP-A-2001-275044 describe an imaging device that perform wide dynamic range imaging using a single imaging element. JP-A-2000-78463 describes an imaging device that can perform wide dynamic range imaging using two imaging elements. In the imaging devices, photographing by firing a flash is not considered.

On the other hand, a paragraph 3 in JP-A-1997-326963 describes an imaging device that can realize wide dynamic range imaging while photographing with a flash. In the imaging device, the light exposure amount is changed in a first field and a second field with one imaging element and the light firing amount of flash of light is changed in each field, whereby it is made possible to provide image data in a wide dynamic range if flash photographing is performed.

However, in the imaging device, long-time exposure and short-time exposure are performed in different photograph fields and thus simultaneity of a subject image provided by long-time exposure and a subject image provided by short-time exposure is not guaranteed and some time shift occurs. Consequently, when a moving subject is photographed, the fluctuating manner of the subject varies from one field to another and a good composite image cannot be provided. The effect of smear varies from one field to another and thus a good composite image cannot be provided.

JP-A-2007-235656 discloses an image device guaranteeing simultaneity of a subject image provided by long-time exposure and a subject image provided by short-time exposure. The imaging device installs a solid-state imaging element including main pixels arranged like a tetragonal lattice and subpixels arranged in the same arrangement as the main pixels and shifted in horizontal and vertical directions from the positions of the main pixels by a half of the arrangement pitch of the pixels. The imaging device drives by making different the exposure time of the main pixel and the exposure time of the subpixel, thereby changing sensitivity of the main pixel and the subpixel and synthesizing a signal obtained from the main pixel and a signal obtained from the subpixel, thereby enlarging the dynamic range.

In the imaging device described in JP-A-2007-235656, the charge stored in the subpixel is previously read during the exposure time period of the main pixel, thereby terminating the exposure time period of the subpixel. That is, control is performed so that the exposure time period of the subpixel overlaps the exposure time period of the main pixel and thus if the subject is a moving subject, a good composite image can be obtained. Since a signal can be read at the same time in the pixel and the subpixel, the effect of smear can be made the same degree in the main pixel and the subpixel.

However, JP-A-2007-235656 does not describe photographing by firing a flash. In an imaging device for controlling so that the exposure time period of the subpixel overlaps the exposure time period of the main pixel like the image device described in Patent Document 5, how a flash is fired becomes a problem to provide a good image if a flash is fired.

### SUMMARY OF THE INVENTION

According to an aspect of the invention, an imaging device includes a CCD-type solid-state imaging element, an imaging control section, a fill light firing section, and a light firing amount calculation section. The CCD-type solid-state imaging element includes a first photoelectric conversion element and a second photoelectric conversion element adjacent to the first photoelectric conversion element. A charge is independently readable from the first photoelectric conversion element and the second photoelectric conversion element. The imaging control section, in response to one photographing command, executes imaging by the solid-state imaging element in two exposure time periods of a first exposure time period exposing the first photoelectric conversion element and a second exposure time period exposing the second photoelectric conversion element. The second exposure time period overlaps the first exposure time period and is shorter than the first exposure time period. The fill light firing section fires fill light. The light firing amount calculation section calculates the light firing amount of the fill light to be fired in the first exposure time period and the second exposure time period before start of the two exposure time periods. In response to the light firing amount calculated by the light firing amount calculation section, the imaging control section selects and executes one of first control of starting the second exposure time period at a midpoint of the first exposure time period and terminating the first exposure time period and the second exposure time period at the same time and second control of starting the first exposure time period and the second exposure time period at the same time and terminating the second exposure time period at a midpoint of the first exposure time period. When the first control is executed, the fill light firing section starts firing the fill light with the light firing amount calculated by the light firing amount calculation section at a first timing just before the start of the second exposure time period. When the second control is executed, the fill light firing section starts firing the fill light with the light firing amount calculated by the light firing amount calculation section at a second timing just before the termination of the second exposure time period. The first timing and the second timing are timing at which light amount of 1/n of the light firing amount calculated by the light firing amount calculation section is fired during the second exposure time period when the first exposure time period is n times the second exposure time period.

### BRIEF DESCRIPTION OF THE DRAWINGS

FIG. 1 is a drawing to show the schematic configuration of a digital camera to describe an exemplary embodiment of the invention;

FIG. 2 is a plan schematic drawing to show the schematic configuration of a solid-state imaging element in the digital camera shown in FIG. 1;

FIG. 3 is a drawing to show an arrangement example of photoelectric conversion elements contained in a light reception section of the solid-state imaging element shown in FIG. 2;

FIG. 4 is a drawing to show an arrangement example of photoelectric conversion elements contained in the light reception section of the solid-state imaging element shown in FIG. 2;

FIG. 5 is a drawing to show an arrangement example of photoelectric conversion elements contained in the light reception section of the solid-state imaging element shown in FIG. 2;

FIG. 6 is a timing chart to describe the operation of the digital camera when a system control section of the digital camera shown in FIG. 1 executes imaging under first imaging control;

FIG. 7 is a timing chart to describe the operation of the digital camera when the system control section of the digital camera shown in FIG. 1 executes imaging under second imaging control;

FIG. 8 is a flowchart to describe an operation example at the fill light firing photographing time in a wide DR photographing mode of the digital camera shown in FIG. 1; and

FIG. 9 is a flowchart to describe an operation example at the fill light firing photographing time in the wide DR photographing mode of the digital camera shown in FIG. 1.

### DETAILED DESCRIPTION

An exemplary embodiment of the invention will be discussed below with reference to the accompanying drawings:

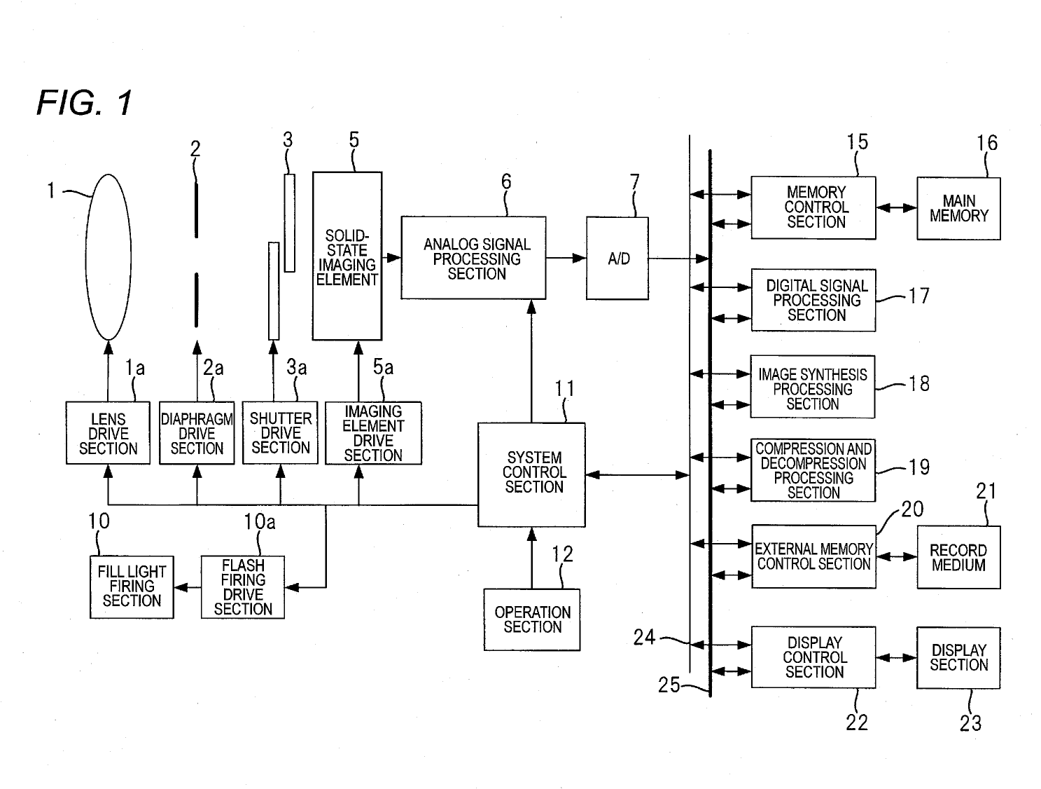

FIG. 1 is a drawing to show the schematic configuration of an imaging device to describe one exemplary embodiment of the invention. Imaging devices include imaging devices of a digital camera, a digital video camera, and the like, imaging modules installed in an electronic endoscope, a mobile telephone with a camera, etc., and the like. In the description to follow, a digital camera is taken as an example.

The digital camera shown in FIG. 1 includes a taking lens 1, a diaphragm 2, a mechanical shutter 3, a solid-state imaging element 5 of CCD (Charge Coupled Device) type, an analog signal processing section 6, an AD conversion section 7, a lens drive section la, a diaphragm drive section 2a, a shutter drive section 3a, an imaging element drive section 5a, system control section 11, a fill light firing section 10, a flash firing drive section 10a, an operation section 12, main memory 16, a memory control section 15 connected to the main memory 16, a digital signal processing section 17, an image combining processing section 18, a compression and decompression processing section 19, and an external memory control section 20 to which a detachable record medium 21 is connected, and a display control section 22 to which a liquid crystal display section 23 installed on the camera rear, etc., is connected.

The diaphragm 2 and the mechanical shutter 3 are provided in this order between the taking lens 1 and the solid-state imaging element 5.

The fill light firing section 10 fires fill light to illuminate a subject at the photographing time and fires fill light (flash of light) with a xenon pipe, an LED, etc.

The system control section 11 controls the lens drive section 1a and adjusts the position of the taking lens 1 to a focus position and makes zoom adjustment. The system control section 11 controls the aperture amount of the diaphragm 2 through the diaphragm drive section 2a to make exposure adjustment and controls opening and closing the mechanical shutter 3 through the shutter drive section 3a. The system control section 11 drives the solid-state imaging element 5 through the imaging element drive section 5a and outputs a subject image picked up through the taking lens 1 as an imaging signal. The system control section 11 fires fill light from the fill light firing section 10 through the light firing drive section 10a. A command signal from the user is input to the system control section 11 through the operation section 12.

The analog signal processing section 6 performs correlation double sampling processing and signal amplification processing for an imaging signal output from the solid-state imaging element 5. The AD conversion section 7 converts the imaging signal after processed in the analog signal processing section 6 into a digital signal. The digital signal processing section 17 performs white balance correction, synchronization processing, gamma correction computation, RGB/YC conversion, etc., for the imaging signal output from the AD conversion section 7 and generates image data.

The image combining processing section 18 synthesizes two pieces of image data different in sensitivity generated in the digital signal processing section 17 and generates wide DR image data with the dynamic range enlarged.

The compression and decompression processing section 19 compresses image data generated in the digital signal processing section 17 and image data generated in the image combining processing section 18 to a JPEG format and decompresses the compressed image data. The image data processed here is recorded on a record medium 21 under the control of the external memory control section 20.

The memory control section 15, the digital signal processing section 17, the image combining processing section 18, the compression and decompression processing section 19, the external memory control section 20, and the display control section 22 are connected to each other by a control bus 24 and a data bus 25 and are controlled by a command from the system control section 11.

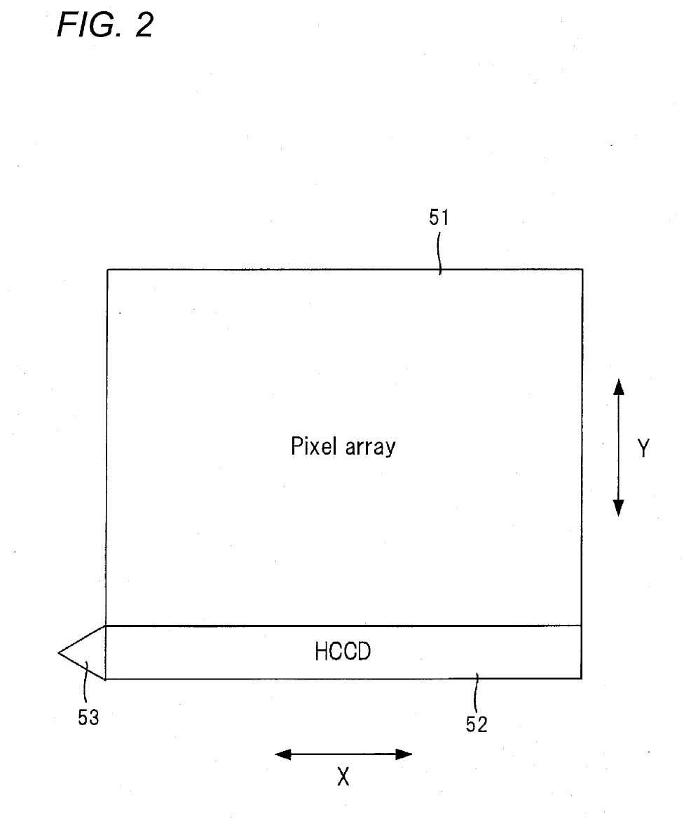

FIG. 2 is a plan schematic drawing to show the schematic configuration of the solid-state imaging element in the digital camera shown in FIG. 1. A light reception section 51, a horizontal charge transfer passage 52, and an output section 53 are formed on a semiconductor substrate of silicon, etc.

In the light reception section, a plurality of lines of photoelectric conversion elements of photodiodes, etc., arranged in a horizontal direction X are arranged in a vertical direction Y orthogonal to the horizontal direction X.

Charge occurring in each photoelectric conversion element of the light reception section is read to a vertical charge transfer passage (not shown) in the light reception section 51 and is transferred in the vertical direction Y. The one-line charge transferred through the vertical charge transfer passage is transferred in the horizontal direction X along the horizontal charge transfer passage 52. The output section 53 for converting the charge into a voltage signal (hereinafter, also called imaging signal) proportional to the charge amount and outputting the signal, such as a floating diffusion amplifier is provided at the termination of the horizontal charge transfer passage 52. The charge transferred in the horizontal direction X is converted into a voltage signal and the signal is output to the outside by the output section 53.

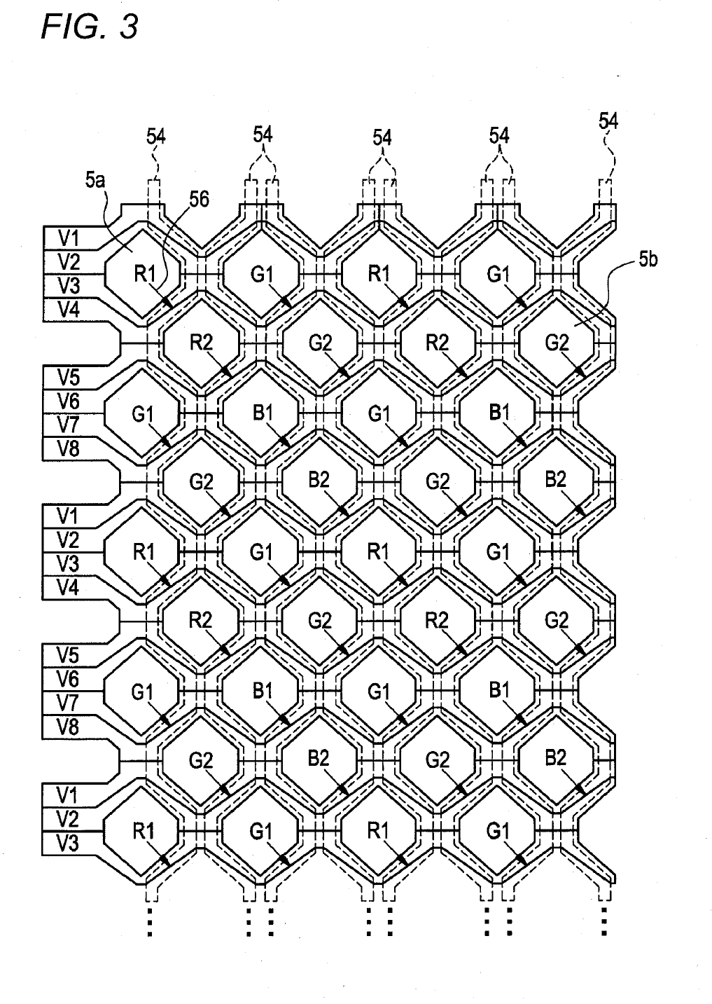

FIGS. 3, 4, and 5 are drawings to show arrangement examples of the photoelectric conversion elements contained in the light reception section 51 of the solid-state imaging element shown in FIG. 2. Each block with “R1,” “R2” shown in FIGS. 3 to 5 indicates a photoelectric conversion element having a red color filter above the light reception face. Each block with “G1,” “G2” indicates a photoelectric conversion element having a green color filter above the light reception face. Each block with “B1,” “B2” indicates a photoelectric conversion element having a blue color filter above the light reception face.

In the example shown in FIG. 3, photoelectric conversion elements 5a arranged like a tetragonal lattice in the horizontal direction and the vertical direction and photoelectric conversion elements 5a arranged like a tetragonal lattice at the same pitch as and as many as the photoelectric conversion elements 5a are placed with a shift of ½ of the arrangement pitch of each photoelectric conversion element in the horizontal and vertical directions. In FIG. 3, the blocks with R1, G1, and B1 are the photoelectric conversion elements 5a and the blocks with R2, G2, and B2 are the photoelectric conversion elements 5b.

As shown in FIG. 3, the color filter arrangement above the photoelectric conversion elements 5a is bayor arrangement and the color filter arrangement above the photoelectric conversion elements 5b is also bayor arrangement. According to such placement, slantingly adjacent to the photoelectric conversion element 5a, the photoelectric conversion element 5b having the color filter of the same color as the color filter above the photoelectric conversion element 5a above exists.

A vertical charge transfer passage 54 is provided corresponding to a photoelectric conversion element column made up of the photoelectric conversion elements arranged in the vertical direction. The vertical charge transfer passage is placed in the right part of the corresponding photoelectric conversion element column and transfers charge read from each photoelectric conversion element in the corresponding photoelectric conversion element column. A charge read area 56 (schematically indicated by an arrow in the figure) to read charge from the photoelectric conversion element to the vertical charge transfer passage 54 is formed between the vertical charge transfer passage 54 and each photoelectric conversion element in the corresponding photoelectric conversion element column.

When a photoelectric conversion element row made up of the photoelectric conversion elements arranged in the horizontal direction is called a line, transfer electrodes V1 to V8 to which a drive pulse is supplied from the imaging element drive section 5a are formed meanderingly in the horizontal line between the lines.

The transfer electrode V2 is formed in an upper part of the odd-numbered line counted from the opposite side to the horizontal charge transfer passage 52 of the photoelectric conversion elements 5a and the transfer electrode V3 is formed in a lower part. The transfer electrode V6 is formed in an upper part of the even-numbered line of the photoelectric conversion elements 5a and the transfer electrode V7 is formed in a lower part.

The transfer electrode V4 is formed in an upper part of the odd-numbered line counted from the opposite side to the horizontal charge transfer passage 52 of the photoelectric conversion elements 5b and the transfer electrode V5 is formed in a lower part. The transfer electrode V8 is formed in an upper part of the even-numbered line of the photoelectric conversion elements 5b and the transfer electrode V1 is formed in a lower part.

The transfer electrode V3 and the transfer electrode V7 also cover an upper part of the charge read area 56 adjacent to the photoelectric conversion element 5a and also serve as read electrodes. A read pulse is applied to the transfer electrode V3 and the transfer electrode V7, whereby charge can be read from the photoelectric conversion element 5a to the vertical charge transfer passage 54.

The transfer electrode V1 and the transfer electrode V5 also cover an upper part of the charge read area 56 adjacent to the photoelectric conversion element 5b and also serve as read electrodes. A read pulse is applied to the transfer electrode V1 and the transfer electrode V5, whereby charge can be read from the photoelectric conversion element 5b to the vertical charge transfer passage 54.

Thus, the read electrode of the photoelectric conversion element 5a and the read electrode of the photoelectric conversion element 5b can be driven independently, so that control for making different the exposure time of the photoelectric conversion element 5a and that of the photoelectric conversion element 5b is possible. According to such a configuration, although the photoelectric conversion element 5a and the photoelectric conversion element 5b are of the same structure, signals different in sensitivity can be output from the photoelectric conversion element 5a and the photoelectric conversion element 5b.

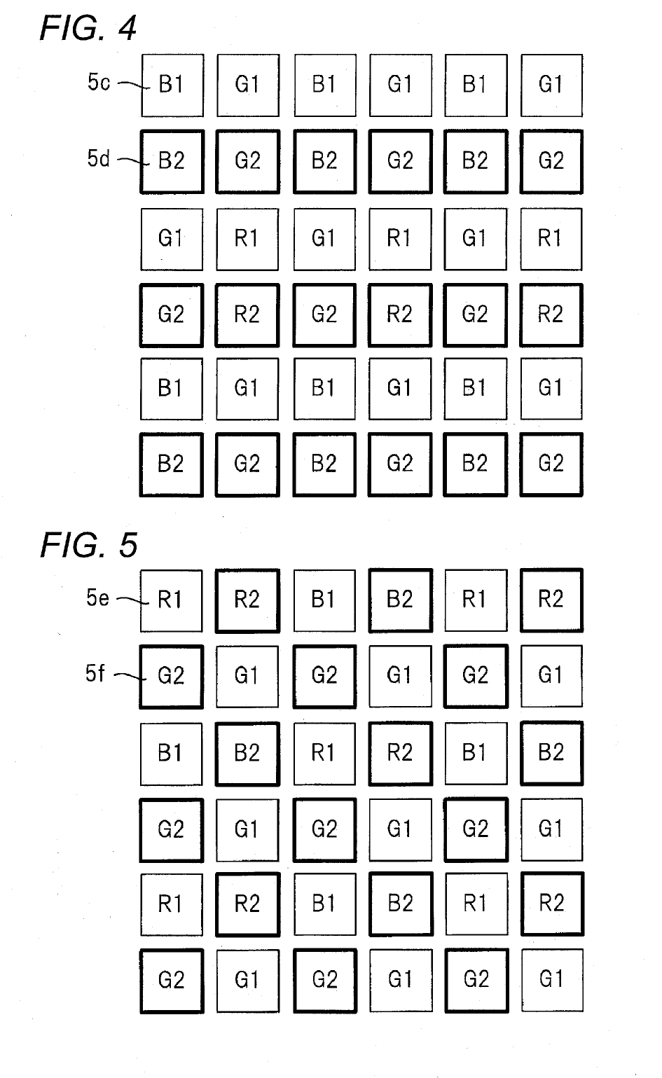

In the example shown in FIG. 4, photoelectric conversion elements 5c arranged like a lattice in the horizontal direction and the vertical direction and photoelectric conversion elements 5d placed like a lattice at the same pitch as and as many as the photoelectric conversion elements 5c are placed with a shift of ½ of the arrangement pitch in the vertical direction of the photoelectric conversion elements 5c. In FIG. 4, the blocks with R1, G1, and B1 are the photoelectric conversion elements 5c and the blocks with R2, G2, and B2 are the photoelectric conversion elements 5d.

As shown in FIG. 4, the color filter arrangement above the photoelectric conversion elements 5c is bayor arrangement and the color filter arrangement above the photoelectric conversion elements 5d is also bayor arrangement. According to such placement, adjacent to the photoelectric conversion element 5c in the vertical direction, the photoelectric conversion element 5d having the color filter of the same color as the color filter above the photoelectric conversion element 5c above exists.

A vertical charge transfer passage is provided corresponding to a photoelectric conversion element column made up of the photoelectric conversion elements arranged in the vertical direction. A charge read area is formed between the photoelectric conversion element column and the vertical charge transfer passage. Read electrodes to read charge from the photoelectric conversion element 5c and the photoelectric conversion element 5d to the vertical charge transfer passage are placed so that charge can be read independently from the photoelectric conversion element 5c and the photoelectric conversion element 5d. Thus, control for making different the exposure time of the photoelectric conversion element 5c and that of the photoelectric conversion element 5d is possible. According to such a configuration, although the photoelectric conversion element 5c and the photoelectric conversion element 5d are of the same structure, signals different in sensitivity can be output from the photoelectric conversion element 5c and the photoelectric conversion element 5d.

In the example shown in FIG. 5, a plurality of photoelectric conversion elements (photoelectric conversion elements 5e and 5f) are arranged like a tetragonal lattice in a horizontal direction and a vertical direction. The photoelectric conversion elements 5e and 5f are placed like check so as to form a checkered pattern as a whole. In FIG. 5, the blocks with R1, G1, and B1 are the photoelectric conversion elements 5e and the blocks with R2, G2, and B2 are the photoelectric conversion elements 5f.

As the photoelectric conversion elements 5e, a line of an R element having a red color filter above a light reception face and a B element having a blue color filter above a light reception face arranged alternately in the horizontal line with the R element as the top and a line of an R element and a B element arranged alternately in the horizontal line with the B element as the top are arranged alternately in the vertical direction with a line of G elements each having a green color filter above a light reception face arranged in the horizontal direction between.

As the photoelectric conversion elements 5f, a line of an R element and a B element arranged alternately in the horizontal line with the R element as the top and a line of an R element and a B element arranged alternately in the horizontal line with the B element as the top are arranged alternately in the vertical direction with a line of G elements arranged in the horizontal line between.

According to such placement, to the right or the left of the photoelectric conversion element 5e, the photoelectric conversion element 5f having the color filter of the same color as the color filter above the photoelectric conversion element 5e above exists.

A vertical charge transfer passage is provided corresponding to a photoelectric conversion element column made up of the photoelectric conversion elements arranged in the vertical direction. A charge read area is formed between the photoelectric conversion element column and the vertical charge transfer passage. Read electrodes to read charge from the photoelectric conversion element 5e and the photoelectric conversion element 5f to the vertical charge transfer passage are placed so that charge can be read independently from the photoelectric conversion element 5e and the photoelectric conversion element 5f. Thus, control for making different the exposure time of the photoelectric conversion element 5e and that of the photoelectric conversion element 5f is possible. According to such a configuration, although the photoelectric conversion element 5c and the photoelectric conversion element 5d are of the same structure, signals different in sensitivity can be output from the photoelectric conversion element 5e and the photoelectric conversion element 5f.

Hereinafter, the photoelectric conversion elements 5a, 5c, and 5e shown in FIGS. 3 to 5 will be called main pixels and the photoelectric conversion elements 5b, 5d and 5f will be called subpixels. A combination of adjacent main pixel and subpixel having the same color filter above the light reception face will be called a pair. It may also be called that each of the arrangements shown in FIGS. 3 to 5 is regular placement of a plurality of pairs.

The digital camera can be set to a high-resolution photographing mode, a high-sensitivity photographing mode, and a wide DR photographing mode for photographing with the dynamic range enlarged.

In the high-resolution photographing mode, the system control section 11 executes imaging in the same exposure time of each main pixel and each subpixel. The digital signal processing section 17 generates high-resolution image data using all signals obtained from the main pixels and the subpixels. The image data is compressed and then is recorded on the record medium 21.

In the high-sensitivity photographing mode, the system control section 11 executes imaging in the same exposure time of each main pixel and each subpixel. The digital signal processing section 17 combines a signal obtained from the main pixel and a signal obtained from the subpixel in each pair and generates high-sensitivity image data using the post-combined signal. The image data is compressed and then is recorded on the record medium 21.

In the wide DR photographing mode, the system control section 11 executes imaging in different exposure times of each main pixel and each subpixel. The digital signal processing section 17 generates main pixel image data from a signal obtained from each main pixel and generates subpixel image data from a signal obtained from each subpixel. The image combining processing section 18 combines the main pixel image data and the subpixel image data, thereby generating wide DR image data with the dynamic range enlarged. The wide DR image data is compressed and then is recorded on the record medium 21.

In the wide DR photographing mode, the system control section 11 performs control to execute imaging by the solid-state imaging element 5 in two exposure time periods of a main pixel exposure time of exposing each main pixel and a subpixel exposure time period of exposing each subpixel, the subpixel exposure time period overlapping the main pixel exposure time period and shorter than the main pixel exposure time period.

In the wide DR photographing mode with firing fill light from the fill light firing section 10 during the execution of photographing, the system control section 11 performs one of first imaging control and second imaging control in response to the light firing amount of fill light to be fired and execute imaging by the solid-state imaging element 5. The reason why one of first imaging control and second imaging control is selected in response to the light firing amount is described later. Specifically, when the light firing amount is larger than a threshold level, the system control section 11 executes the first imaging control; when the light firing amount is equal to or less than the threshold level, the system control section 11 executes the second imaging control.

The first imaging control is control of starting a subpixel exposure time period at a midpoint of a main pixel exposure time period and terminating the main pixel exposure time period and the subpixel exposure time period at the same time. The second imaging control is control of starting the main pixel exposure time period and the subpixel exposure time period at the same time and terminating the subpixel exposure time period at a midpoint of the main pixel exposure time period.

To execute photographing by firing fill light in the wide DR photographing mode and precisely enlarging the dynamic range, assuming that the ratio between the main pixel exposure time period and the subpixel exposure time period is n:m, the light firing amount of the fill light needs to be precisely controlled at n:m between the main pixel exposure time period and the subpixel exposure time period. Then, in the digital camera, when the first imaging control is executed, the light firing drive section 10a starts firing fill light at a first timing just before the start of the subpixel exposure time period and when the second imaging control is executed, the light firing drive section 10a starts firing fill light at a second timing just before the termination of the subpixel exposure time period. The first timing and the second timing need to be timing at which light amount of 1/n of the light firing amount of the fill light to be fired is fired during the subpixel exposure time period when the main pixel exposure time period is n times the subpixel exposure time period.

In the digital camera, the first imaging control and the second imaging control are switched in response to the light firing amount of fill light, whereby it is made possible to precisely enlarge the dynamic range if fill light is fired and photographing is performed.

An operation example of the digital camera when fill light is fired and photographing is performed in the wide DR photographing mode will be discussed below: First, the operation of the digital camera when the first imaging control described above is executed and the operation of the digital camera when the second imaging control described above is executed will be discussed.

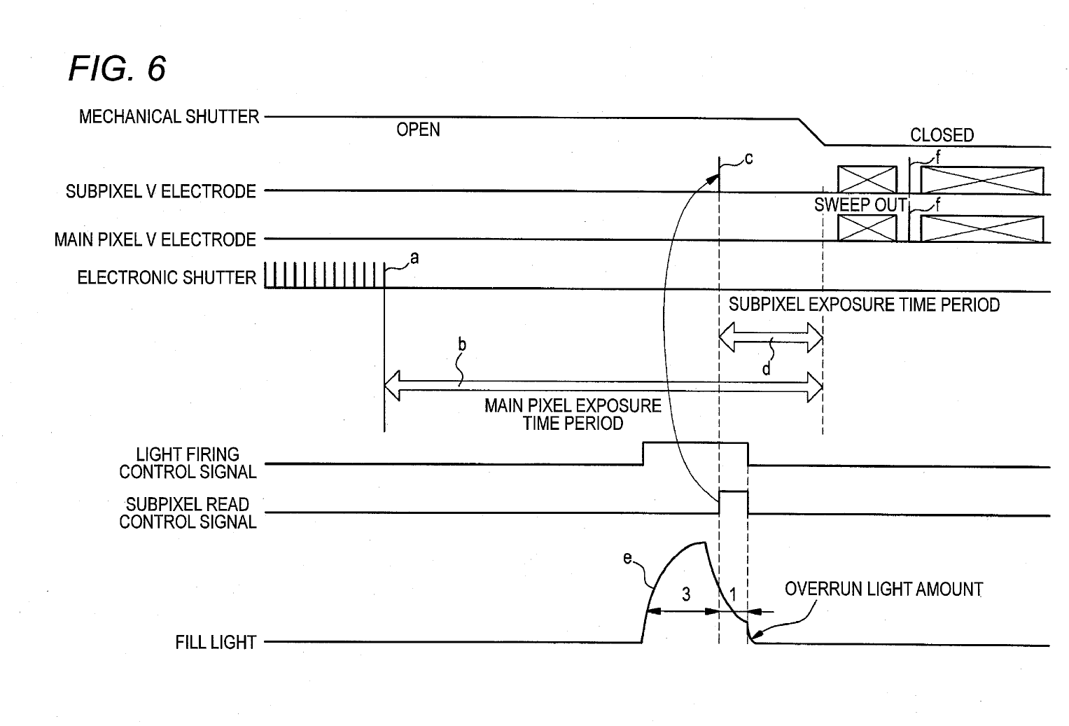

FIG. 6 is a timing chart to describe the operation of the digital camera when the system control section of the digital camera shown in FIG. 1 performs imaging under the first imaging control. In FIG. 6, “mechanical shutter” indicates the state of the mechanical shutter 3. “Subpixel V electrode” indicates the state of a pulse applied to the read electrode corresponding to a main pixel. “Electronic shutter” indicates the state of an electronic shutter pulse applied to the semiconductor substrate of the solid-state imaging element 5. “Light firing control signal” is a command signal of start and termination of fill light firing supplied from the system control section 11 to the light firing drive section 10a. “Subpixel read control signal” is a command signal of charge read from each subpixel supplied from the system control section 11 to the imaging element drive section 5a. “Fill light” indicates the state of fill light fired from the fill light firing section 10.

In the example in FIG. 6, the main pixel exposure time period is four times the subpixel exposure time period and the ratio between the light firing amount of fill light fired in the main pixel exposure time period and the light firing amount of fill light fired in the subpixel exposure time period is controlled to 4:1. The system control section 11 calculates the light firing amount of fill light fired during photographing according to a TTL (Through The Lens) dimming control system. That is, fill light is fired in any light firing amount by the fill light firing section 10 before photographing and the light firing amount is calculated based on an imaging signal obtained by imaging in the solid-state imaging element at the light firing time.

To perform the first imaging control, when the user gives a photographing command, the system control section 11 turns off an electronic shutter pulse a, places the electronic shutter in a “closed” state, and starts a main pixel exposure time period b. When ¾ of the main pixel exposure time period b have elapsed, the system control section 11 supplies a subpixel read control signal to the imaging element drive section 5a. Accordingly, a read pulse c is applied to the read electrode corresponding to a subpixel, unnecessary charge stored in the subpixel from the start of the main pixel exposure period b to the time is read to the vertical charge transfer passage, and a subpixel exposure time period d is started.

The system control section 11 makes a light firing control signal high at the first timing just before the start of the subpixel exposure time period d and fires a predetermined amount of fill light calculated according to the TTL dimming control system. As shown in FIG. 6, when the light firing control signal goes high, firing of fill light e is started and when the light firing control signal goes low, firing of the fill light e is stopped. The light firing amount of the fill light may be controlled according to the time from the firing start to the firing stop of the fill light by the fill light firing section 10. That is, the time during which the light firing control signal is made high is controlled, whereby it is possible to fire the predetermined amount of fill light.

The system control section 11 determines the first timing so that the completion timing of firing of ¾ of the total light firing amount of the fill light fired in the time period during which the light firing control signal is made high and the applying timing of the read pulse c match, and starts firing the fill light from the fill light firing section 10 at the first timing. The system control section 11 makes the light firing control signal low for stopping firing the fill light and then closes the mechanical shutter 3 at the termination timing of the main pixel exposure period b and the subpixel exposure time period d and terminates the main pixel exposure period b and the subpixel exposure time period d. After the termination of the main pixel exposure period b and the subpixel exposure time period d, the system control section 11 sweeps out unnecessary charge existing on the vertical charge transfer passage and then applies a read pulse f to the read electrode corresponding to a main pixel and a subpixel, reads the charge stored in the main pixel and the subpixel to the vertical charge transfer passage, transfers the read charge, and outputs a signal responsive to the charge from the solid-state imaging element 5.

The solid-state imaging element 5 is thus driven, whereby the ratio between the light firing amount of the fill light fired in the main pixel exposure period b and the light firing amount of the fill light fired in the subpixel exposure period d can be made almost the same as the ratio between the main pixel exposure period b and the subpixel exposure period d. Consequently, the ratio between the exposure amount in the main pixel exposure period b and the exposure amount in the subpixel exposure period d can be made almost the same as the ratio between the main pixel exposure period b and the subpixel exposure period d and the dynamic range can be enlarged at the magnification based on the ratio between the main pixel exposure period b and the subpixel exposure period d.

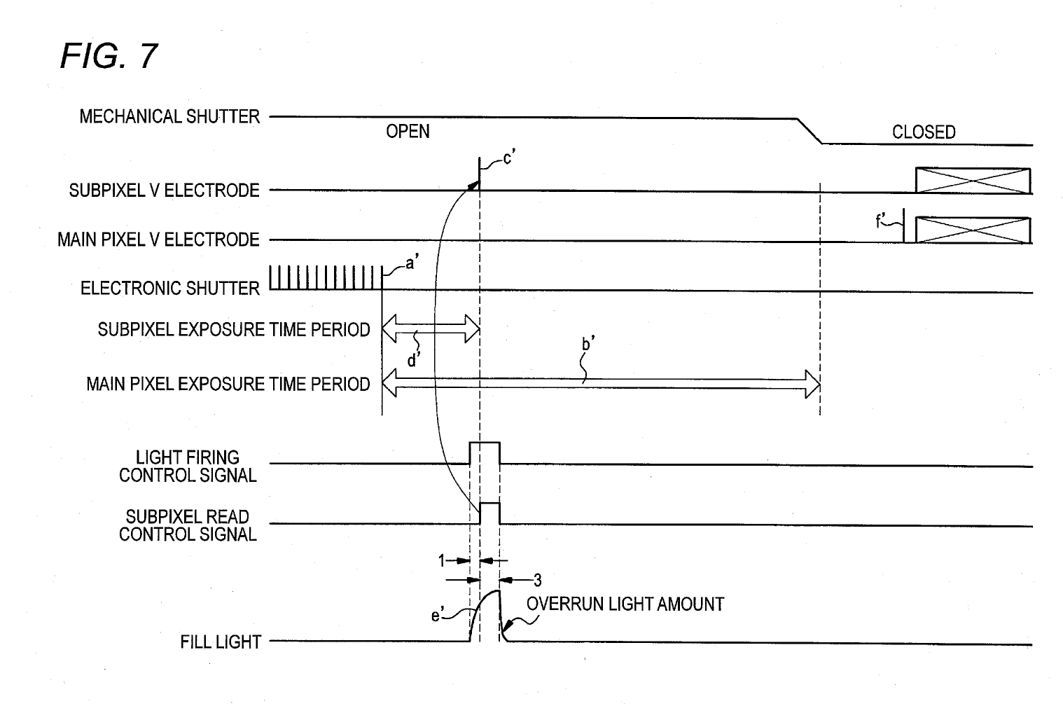

FIG. 7 is a timing chart to describe the operation of the digital camera when the system control section of the digital camera shown in FIG. 1 performs imaging under the second imaging control. Representations shown in FIG. 7 are similar to those shown in FIG. 6. In the example in FIG. 7, the main pixel exposure time period is also four times the subpixel exposure time period and the ratio between the light firing amount of fill light fired in the main pixel exposure time period and the light firing amount of fill light fired in the subpixel exposure time period is also controlled to 4:1.

To perform the second imaging control, when the user gives a photographing command, the system control section 11 turns off the electronic shutter pulse a, places the electronic shutter in an “open” state, and starts a main pixel exposure time period b′ and a subpixel exposure time period d′ at the same time. When ¼ of the main pixel exposure time period b′ have elapsed, the system control section 11 supplies a subpixel read control signal to the imaging element drive section 5a. Accordingly, a read pulse c′ is applied to the read electrode corresponding to a subpixel, the charge stored in the subpixel in the subpixel exposure time period d′ is read to the vertical charge transfer passage, and the subpixel exposure time period d′ is terminated.

The system control section 11 makes a light firing control signal high at the second timing just before the start of the subpixel exposure time period d′ and fires a predetermined amount of fill light calculated according to the TTL dimming control system. As shown in FIG. 7, when the light firing control signal goes high, firing of fill light e′ is started and when the light firing control signal goes low, firing of the fill light e′ is stopped. The light firing amount of the fill light may be controlled according to the time from the firing start to the firing stop of the fill light by the fill light firing section 10. That is, the time during which the light firing control signal is made high is controlled, whereby it is possible to fire the predetermined amount of fill light.

The system control section 11 determines the second timing so that the completion timing of firing of ¼ of the total light firing amount of the fill light fired in the time period during which the light firing control signal is made high and the applying timing of the read pulse c′ match, and starts firing the fill light from the fill light firing section 10 at the second timing. The system control section 11 makes the light firing control signal low for stopping firing the fill light and then closes the mechanical shutter 3 at the termination timing of the main pixel exposure period b′ and terminates the main pixel exposure period b′. After the termination of the main pixel exposure period b′, the system control section 11 applies a read pulse f′ to the read electrode corresponding to a main pixel, reads the charge stored in the main pixel to the vertical charge transfer passage. The system control section 11 transfers the charge read with the read pulse c′ and the read pulse f′, and outputs a signal responsive to the charge from the solid-state imaging element 5.

The solid-state imaging element 5 is thus driven, whereby the ratio between the light firing amount of the fill light fired in the main pixel exposure period b′ and the light firing amount of the fill light fired in the subpixel exposure period d′ can be made almost the same as the ratio between the main pixel exposure period b′ and the subpixel exposure period d′. Consequently, the ratio between the exposure amount in the main pixel exposure period b′ and the exposure amount in the subpixel exposure period d′ can be made almost the same as the ratio between the main pixel exposure period b′ and the subpixel exposure period d′ and thus the dynamic range can be enlarged at the magnification based on the ratio between the main pixel exposure period b′ and the subpixel exposure period d′.

As shown in FIGS. 6 and 7, the light firing amount of the fill light does not become zero just when the light firing control signal goes low; the fill light is gradually attenuated and the light firing amount becomes zero. The light firing amount of the fill light fired from the fill light firing section 10 from the light firing stop of the fill light until the light firing amount of the fill light actually becomes zero is called overrun light amount. The overrun light amount becomes smaller as the light firing amount of the fill light is larger. Since the overrun light amount occurs after the light firing control signal is made low, in the first imaging control, the overrun light amount is contained in the light firing amount of the fill light fired in the subpixel exposure time period d; in the second imaging control, the overrun light amount is contained in the light firing amount of the fill light fired in the main pixel exposure time period b′. Therefore, the ratio between the exposure amount in the main pixel exposure time period and the exposure amount in the subpixel exposure time period deviates from the desired value because of the overrun light amount and there is a possibility that the image quality may be affected.

In the digital camera, to minimize the effect on the image quality caused by the overrun light amount, when the overrun light amount becomes small, namely, when the light firing amount of the fill light is large, the first imaging control of control in which the overrun light amount is contained in the subpixel exposure time period is executed. When the overrun light amount becomes large, namely, when the light firing amount of the fill light is small, the second imaging control of control in which the overrun light amount is contained only in the main pixel exposure time period is executed.

Since the subpixel exposure time period is shorter than the main pixel exposure time period, if fill light of a large overrun light is fired in the time period, the effect on the image quality cannot be ignored. Thus, when the overrun light amount is large, the second imaging control is executed, whereby the effect on the image quality can be minimized.

It is also considered that the second imaging control is always executed regardless of whether the overrun light amount is large or small. However, in the second imaging control, it is necessary to hold the charge of each subpixel in the vertical charge transfer passage during the main pixel exposure time period and thus there is a possibility that noise of smear, a dark current, etc., may mix in the hold time period. Before charge is read from each main pixel, drive of sweeping out unnecessary charge in the vertical charge transfer passage cannot be executed and thus noise also increases from this point. In contrast, in the first imaging control, unnecessary charge on the transfer passage can be swept out before charge is read from each main pixel and each subpixel and thus noise can be lessened. Therefore, the second imaging control is executed only when the overrun light amount is large and the effect on the image quality becomes large, whereby degradation of the image quality can be suppressed as much as possible.

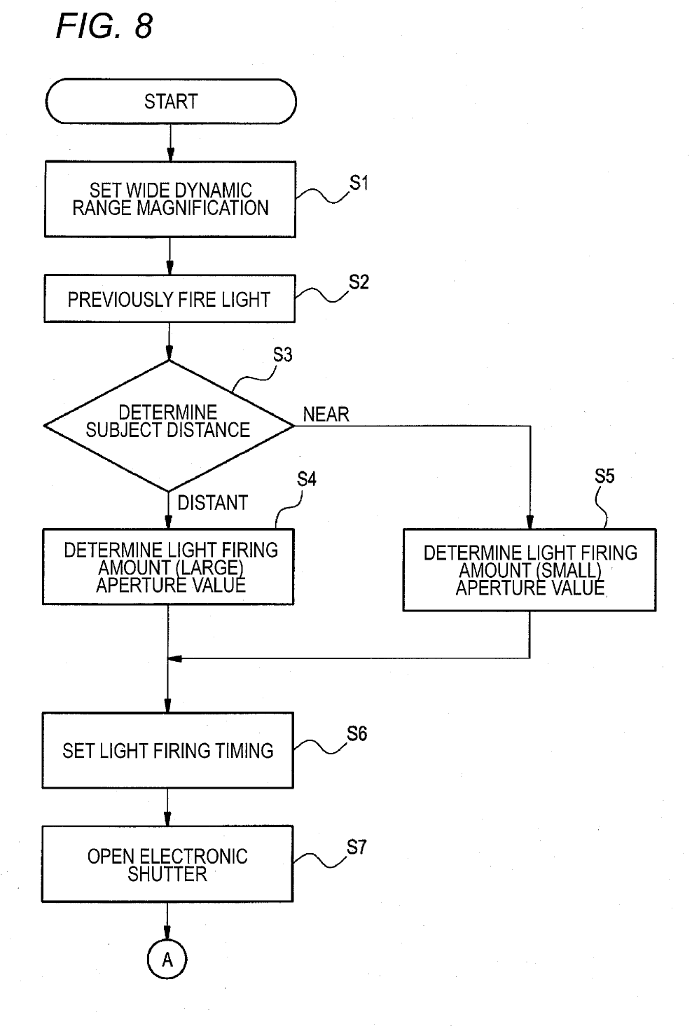

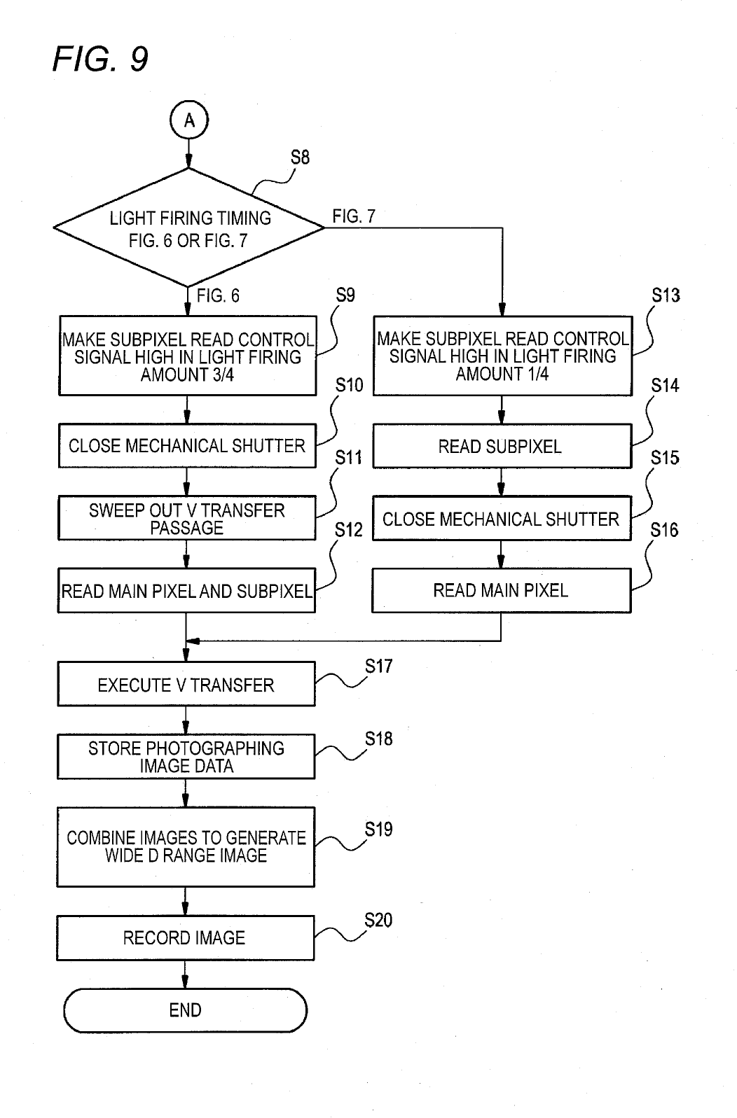

Next, the operation at the fill light firing photographing time in the wide DR photographing mode of the digital camera shown in FIG. 1 will be discussed with flowcharts of FIGS. 8 and 9.

When the digital camera is set to the wide DR photographing mode, the system control section 11 sets dynamic range enlargement magnification (step S1). The dynamic range enlargement magnification may be automatically set based on photographing image data read from the solid-state imaging element 5 or a value previously specified by the user may be set.

Next, when the user half pushes a release button contained in the operation section 12 and gives a command of AE (auto exposure), AF (auto focus), the system control section 11 executes pre-imaging by the solid-state imaging element 5 and causes the fill light firing section 10 to fire a predetermined amount of fill light during the pre-imaging (step S2). The pre-imaging may be executed, for example, by exposing all pixels at the same time and reading a signal from all pixels as at the high-resolution photographing mode or by exposing only the main pixels or the subpixels of the solid-state imaging element 5 and reading a signal from the main pixels or the subpixels.

After the termination of the pre-imaging, the system control section 11 determines the distance to a main subject based on an imaging signal output from the solid-state imaging element 5 by the pre-imaging (step S3). The distance to the main subject may be determined according to another known technique. For example, light may be applied from the digital camera to the subject, reflected light from the subject may be detected, and the distance to the main subject may be determined based on the detected light amount. The digital camera may install means that can determine the distance to the main subject, and known means may be used as the means.

The system control section 11 calculates the light firing amount of the fill light in response to the distance to the main subject and sets the amount. If the distance to the main subject exceeds a predetermined value (step S3: Distant), the system control section 11 calculates a relatively large light firing amount and sets the amount (step S4). On the other hand, if the distance to the main subject is equal to or less than the predetermined value (step S3: Near), the system control section 11 calculates a relatively smaller light firing amount than that when “step S3: Distance” as the light firing amount of the fill light and sets the amount (step S5). The system control section 11 calculates and sets the light firing amount at step S4 or S5 and also executes AE, AF processing based on the imaging signal output from the solid-state imaging element 5 by the pre-imaging and sets an exposure condition. The method of previously firing the fill light, executing imaging, and calculating the light firing amount of the fill light from data obtained by the imaging is the above-described TTL dimming control system.

Next, the system control section 11 sets the light firing timing of the fill light (the timing at which the light firing control signal is made high shown in FIGS. 6 and 7) in accordance with the magnitude of the light firing amount set step S4 or S5 (step S6). For example, when the setup light firing amount is larger than the threshold level, the timing shown in FIG. 6 is set and when the setup light firing amount is equal to or less than the threshold level, the timing shown in FIG. 7 is set.

After the light firing timing of the fill light is set, when the user fully pushes the release button contained in the operation section 12 and gives a photographing command for record, the system control section 11 “opens” the electronic shutter and starts the main pixel exposure time period (step S7).

If the light firing timing of the fill light set at step S6 is the light firing timing shown in FIG. 6 (step S8: FIG. 6), the system control section 11 starts firing the fill light just before ¾ of the main pixel exposure time period have elapsed, and when ¾ of the main pixel exposure time period have elapsed, the system control section 11 reads unnecessary charge from each subpixel and starts the subpixel exposure time period (step S9).

Next, the system control section 11 closes the mechanical shutter 3 and terminates the main pixel exposure time period and the subpixel exposure time period at the same time (step S10). After step S10, the system control section 11 sweeps out unnecessary charge in the vertical charge transfer passage at high speed (step S11) and then charge is read from each main pixel and each subpixel to the vertical charge transfer passage (step S12).

If the light firing timing of the fill light set at step S6 is the light firing timing shown in FIG. 7 (step S8: FIG. 7), the system control section 11 starts firing the fill light just before ¼ of the main pixel exposure time period have elapsed (step S13), and when ¼ of the main pixel exposure time period have elapsed, the system control section 11 reads charge from each subpixel and terminates the subpixel exposure time period (step S14). After step S14, the system control section 11 closes the mechanical shutter 3 and terminates the main pixel exposure time period (step S15) and then reads charge of each main pixel to the vertical charge transfer passage (step S16).

After step S12 and step S16, the system control section 11 transfers charge from each main pixel and charge from each subpixel read to the vertical charge transfer passage and outputs a signal responsive to the charge from the solid-state imaging element 5 (step S17). After this, the digital signal processing section 17 generates main pixel image data from the signal obtained from each main pixel, generates subpixel image data from the signal obtained from each subpixel, and stores them in the main memory (step S18). Next, the image combining processing section 18 combines the main pixel image data and the subpixel image data to generate wide DR image data (step S19). Next, the external memory control section 20 records the wide DR image data on the record medium (step S20) and the imaging operation terminates.

As described above, according to the digital camera, the control shown in FIG. 6 and the control shown in FIG. 7 is selectively executed in response to the magnitude of the light firing amount of the fill light fired at the photographing time (in other words, the magnitude of the overrun light amount), so that the effect on the image quality after the dynamic range is enlarged can be minimized.

According to the control shown in FIGS. 6 and 7, the main pixel exposure time period and the subpixel exposure time period overlap and thus if the subject is a moving subject, a high-quality image can be provided. The effect of smear in the main pixel exposure time period and that in the subpixel exposure time period can be made almost the same, so that the dynamic range can be enlarged precisely.

As described above, the Specification discloses the following items:

A disclosed imaging device includes a CCD-type solid-state imaging element including a first photoelectric conversion element and a second photoelectric conversion element adjacent thereto from which a charge can be read independently; an imaging control section being responsive to one photographing command for performing control to execute imaging by the solid-state imaging element in two exposure time periods of a first exposure time period exposing the first photoelectric conversion element and a second exposure time period exposing the second photoelectric conversion element, the second exposure time period overlapping the first exposure time period and shorter than the first exposure time period; a fill light firing section for firing fill light; and a light firing amount calculation section for calculating the light firing amount of the fill light to be fired in the first exposure time period and the second exposure time period before start of the two exposure time periods, wherein the imaging control section is responsive to the light firing amount calculated by the light firing amount calculation section for selecting and executing one of first control of starting the second exposure time period at a midpoint of the first exposure time period and terminating the first exposure time period and the second exposure time period at the same time and second control of starting the first exposure time period and the second exposure time period at the same time and terminating the second exposure time period at a midpoint of the first exposure time period, wherein when the first control is executed, the fill light firing section starts firing the fill light of the light firing amount calculated by the light firing amount calculation section at a first timing just before the start of the second exposure time period and when the second control is executed, the fill light firing section starts firing the fill light of the light firing amount calculated by the light firing amount calculation section at a second timing just before the termination of the second exposure time period, and wherein the first timing and the second timing are timing at which light amount of 1/n of the light firing amount calculated by the light firing amount calculation section is fired during the second exposure time period when the first exposure time period is n times the second exposure time period.

According to the configuration, one of the first control and the second control is executed in response to the light firing amount of the fill light fired in response to the photographing command, and the fill light can be fired in both the first exposure time period and the second exposure time period at the first control time and at the second control time. One of the first control and the second control is executed in response to the light firing amount of the fill light, whereby it is made possible to minimize the effect on the image quality caused by the overrun light amount fired from the fill light firing section from the fill light reaching the light firing amount calculated by the firing amount calculation section to the light firing amount of the fill light becoming zero, and it is made possible to enlarge the precise dynamic range.

In the disclosed imaging device, when the light firing amount calculated by the light firing amount calculation section is larger than a threshold level, the imaging control section executes the first control and when the light firing amount calculated by the light firing amount calculation section is equal to or less than the threshold level, the imaging control section executes the second control.

When the light firing amount is equal to or less than the threshold level, the overrun light amount increases. Thus, as in the configuration described above, the second control is executed and the overrun light amount is emitted in the first exposure time period, whereby the effect on the image quality caused by the overrun light amount can be minimized.

In the disclosed imaging device, the imaging control section starts the first exposure time period by stopping applying an electronic shutter pulse and terminates the first exposure time period by “closing” a mechanical shutter.

According to the configuration, the effect of smear, etc., is excluded and higher image quality can be accomplished.

In the disclosed imaging device, at the first control time, the imaging control section closes the mechanical shutter and then sweeps out unnecessary charge existing on a charge transfer passage of the solid-state imaging element before reading charge from the first photoelectric conversion element and the second photoelectric conversion element to the charge transfer passage. In the disclosed imaging device, the solid-state imaging element has a plurality of pairs placed regularly on a substrate, each pair made up of the first photoelectric conversion element and the second photoelectric conversion element adjacent thereto.

In the disclosed imaging device, the first photoelectric conversion elements and the second photoelectric conversion elements are arranged like a tetragonal lattice in a horizontal direction and a vertical direction orthogonal thereto at the same pitch, and the second photoelectric conversion element is placed at a position where the first photoelectric conversion element is shifted in the horizontal direction and the vertical direction by ½ of the pitch.

In the disclosed imaging device, the light firing amount calculation section calculates the light firing amount according to a TTL dimming control system.

A disclosed imaging method using a CCD-type solid-state imaging element including a first photoelectric conversion element and a second photoelectric conversion element adjacent thereto from which a charge can be read independently includes an imaging control step being responsive to one photographing command for performing control to execute imaging by the solid-state imaging element in two exposure time periods of a first exposure time period exposing the first photoelectric conversion element and a second exposure time period exposing the second photoelectric conversion element, the second exposure time period overlapping the first exposure time period and shorter than the first exposure time period; a fill light firing step of firing fill light; and a light firing amount calculation step of calculating the light firing amount of the fill light to be fired in the first exposure time period and the second exposure time period before start of the two exposure time periods, wherein the imaging control step is responsive to the light firing amount calculated in the light firing amount calculation step for selecting and executing one of first control of starting the second exposure time period at a midpoint of the first exposure time period and terminating the first exposure time period and the second exposure time period at the same time and second control of starting the first exposure time period and the second exposure time period at the same time and terminating the second exposure time period at a midpoint of the first exposure time period, wherein when the first control is executed, the fill light firing step starts firing the fill light of the light firing amount calculated in the light firing amount calculation step at a first timing just before the start of the second exposure time period and when the second control is executed, the fill light firing step starts firing the fill light of the light firing amount calculated in the light firing amount calculation step at a second timing just before the termination of the second exposure time period, and wherein the first timing and the second timing are timing at which light amount of 1/n of the light firing amount calculated in the light firing amount calculation step is fired during the second exposure time period when the first exposure time period is n times the second exposure time period.

In the disclosed imaging method, when the light firing amount calculated in the light firing amount calculation step is larger than a threshold level, the imaging control step executes the first control and when the light firing amount calculated in the light firing amount calculation step is equal to or less than the threshold level, the imaging control step executes the second control.

In the disclosed imaging method, the imaging control step starts the first exposure time period by stopping applying an electronic shutter pulse and terminates the first exposure time period by “closing” a mechanical shutter.

In the disclosed imaging method, at the first control time, the imaging control step closes the mechanical shutter and then sweeps out unnecessary charge existing on a charge transfer passage of the solid-state imaging element before reading charge from the first photoelectric conversion element and the second photoelectric conversion element to the charge transfer passage.

In the disclosed imaging method, the solid-state imaging element has a plurality of pairs placed regularly on a substrate, each pair made up of the first photoelectric conversion element and the second photoelectric conversion element adjacent thereto.

In the disclosed imaging method, the first photoelectric conversion elements and the second photoelectric conversion elements are arranged like a tetragonal lattice in a horizontal direction and a vertical direction orthogonal thereto at the same pitch, and the second photoelectric conversion element is placed at a position where the first photoelectric conversion element is shifted in the horizontal direction and the vertical direction by ½ of the pitch.

In the disclosed imaging method, the light firing amount calculation step calculates the light firing amount according to a TTL dimming control system.

### [Description of Reference Numerals]

5 Solid-state imaging element
5a Imaging element drive section
10 Fill light firing section
11 System control section
17 Digital signal processing section

What is claimed is:

1. An imaging device comprising:
a CCD-type solid-state imaging element that includes a first photoelectric conversion element and a second photoelectric conversion element adjacent to the first photoelectric conversion element, a charge being independently readable from the first photoelectric conversion element and the second photoelectric conversion element;
an imaging control section that, in response to one photographing command, executes imaging by the solid-state imaging element in two exposure time periods of a first exposure time period exposing the first photoelectric conversion element and a second exposure time period exposing the second photoelectric conversion element, the second exposure time period overlapping the first exposure time period and shorter than the first exposure time period;
a fill light firing section that fires fill light; and
a light firing amount calculation section that calculates the light firing amount of the fill light to be fired in the first exposure time period and the second exposure time period before start of the two exposure time periods,
wherein, in response to the light firing amount calculated by the light firing amount calculation section, the imaging control section selects and executes one of first control of starting the second exposure time period at a midpoint of the first exposure time period and terminating the first exposure time period and the second exposure time period at the same time and second control of starting the first exposure time period and the second exposure time period at the same time and terminating the second exposure time period at a midpoint of the first exposure time period,
when the first control is executed, the fill light firing section starts firing the fill light with the light firing amount calculated by the light firing amount calculation section at a first timing just before the start of the second exposure time period,
when the second control is executed, the fill light firing section starts firing the fill light with the light firing amount calculated by the light firing amount calculation section at a second timing just before the termination of the second exposure time period, and
wherein the first timing and the second timing are timing at which light amount of 1/n of the light firing amount calculated by the light firing amount calculation section is fired during the second exposure time period when the first exposure time period is n times the second exposure time period.

2. The imaging device according to claim 1, wherein when the light firing amount calculated by the light firing amount calculation section is larger than a threshold level, the imaging control section executes the first control and when the light firing amount calculated by the light firing amount calculation section is equal to or less than the threshold level, the imaging control section executes the second control.

3. The imaging device according to claim 1, wherein the imaging control section starts the first exposure time period by stopping applying an electronic shutter pulse and terminates the first exposure time period by “closing” a mechanical shutter.

4. The imaging device according to claim 3, wherein at the first control time, the imaging control section closes the mechanical shutter and then sweeps out unnecessary charge existing on a charge transfer passage of the solid-state imaging element before reading charge from the first photoelectric conversion element and the second photoelectric conversion element to the charge transfer passage.

5. The imaging device according to claim 1, wherein the solid-state imaging element has a plurality of pairs placed regularly on a substrate, each pair made up of the first photoelectric conversion element and the second photoelectric conversion element adjacent thereto.

6. The imaging device according to claim 5, wherein the first photoelectric conversion elements and the second photoelectric conversion elements are arranged like a tetragonal lattice in a horizontal direction and a vertical direction orthogonal thereto at the same pitch, and wherein
the second photoelectric conversion element is placed at a position where the first photoelectric conversion element is shifted in the horizontal direction and the vertical direction by ½ of the pitch.

7. The imaging device according to claim 1, wherein the light firing amount calculation section calculates the light firing amount according to a TTL dimming control system.

8. An imaging method using a CCD-type solid-state imaging element that includes a first photoelectric conversion element and a second photoelectric conversion element adjacent to the first photoelectric conversion element, a charge being independently readable from the first photoelectric conversion element and the second photoelectric conversion element, the method comprising:
in response to one photographing command, executing imaging by the solid-state imaging element in two exposure time periods of a first exposure time period exposing the first photoelectric conversion element and a second exposure time period exposing the second photoelectric conversion element, the second exposure time period overlapping the first exposure time period and shorter than the first exposure time period;
firing fill light; and
calculating the light firing amount of the fill light to be fired in the first exposure time period and the second exposure time period before start of the two exposure time periods,
wherein in response to the light firing amount calculated by the light firing amount calculation section, the imaging control section selects and executes one of first control of starting the second exposure time period at a midpoint of the first exposure time period and terminating the first exposure time period and the second exposure time period at the same time and second control of starting the first exposure time period and the second exposure time period at the same time and terminating the second exposure time period at a midpoint of the first exposure time period,
wherein when the first control is executed, the fill light firing section starts firing the fill light with the calculated light firing amount at a first timing just before the start of the second exposure time period,
wherein when the second control is executed, the fill light firing section starts firing the fill light with the calculated light firing amount at a second timing just before the termination of the second exposure time period, and
wherein the first timing and the second timing are timing at which light amount of 1/n of the calculated light firing amount is fired during the second exposure time period when the first exposure time period is n times the second exposure time period.

9. The imaging method according to claim 8 wherein when the calculated light firing amount is larger than a threshold level, the imaging control step executes the first control and when the light firing amount calculated in the light firing amount calculation step is equal to or less than the threshold level, the imaging control step executes the second control.

10. The imaging method according to claim 8, wherein the imaging control step starts the first exposure time period by stopping applying an electronic shutter pulse and terminates the first exposure time period by “closing” a mechanical shutter.

11. The imaging method according to claim 10, wherein at the first control time, the imaging control step closes the mechanical shutter and then sweeps out unnecessary charge existing on a charge transfer passage of the solid-state imaging element before reading charge from the first photoelectric conversion element and the second photoelectric conversion element to the charge transfer passage.

12. The imaging method according to claim 8, wherein the solid-state imaging element has a plurality of pairs placed regularly on a substrate, each pair made up of the first photoelectric conversion element and the second photoelectric conversion element adjacent thereto.

13. The imaging method according to claim 12, wherein the first photoelectric conversion elements and the second photoelectric conversion elements are arranged like a tetragonal lattice in a horizontal direction and a vertical direction orthogonal thereto at the same pitch, and
wherein the second photoelectric conversion element is placed at a position where the first photoelectric conversion element is shifted in the horizontal direction and the vertical direction by ½ of the pitch.

14. The imaging method according to claim 8, wherein the light firing amount calculation step calculates the light firing amount according to a TTL dimming control system.
